(19) United States
(12) Patent Application Publication
(10) Pub. No.: US 2012/0063801 A1
(43) Pub. Date: Mar. 15, 2012

(54) IMAGE FORMING APPARATUS DISPLAYING GUIDANCE IMAGE

(75) Inventors: Toshikazu Higashi, Toyokawa-shi (JP); Hiroshi Eguchi, Okazaki-shi (JP); Tatsuya Eguchi, Toyohashi-shi (JP)

(73) Assignee: Konica Minolta Business Technologies, Inc., Chiyoda-ku (JP)

(21) Appl. No.: 13/229,246

(22) Filed: Sep. 9, 2011

(30) Foreign Application Priority Data
Sep. 14, 2010 (JP) 2010-205607

(51) Int. Cl. G03G 15/00

(52) U.S. Cl. 399/81

(57) ABSTRACT

In an image forming apparatus, an image is formed on a sheet, a guidance image for guiding an operation procedure is displayed, and a state of the image forming apparatus related to the operation procedure is detected. In the image forming apparatus, a supplemental image for indicating a difference between the operation procedure displayed by the guidance image and an operation procedure required in the detected state is displayed together with the guidance image.

This application is based on Japanese Patent Application No. 2010-205607 filed with the Japan Patent Office on Sep. 14, 2010, the entire content of which is hereby incorporated by reference.

### BACKGROUND OF THE INVENTION

1. Field of the Invention

The present invention relates to an image forming apparatus, and particularly to an image forming apparatus displaying a guidance image for providing an operation procedure to a user.

2. Description of the Related Art

As this type of image forming apparatus, there has been known an image forming apparatus having a function of guiding an operation procedure by images in accordance with an operation of the Help key. There has also been known an image forming apparatus having a function of automatically displaying a guidance image when an operation including jamming processing or replacement of consumable products such as staples is required.

Japanese Laid-Open Patent Publication No. 08-123259, for example, discloses an image forming apparatus displaying a message indicating the need for toner replenishment and apparatus displaying guidance of a toner replenishment operation in detail by a moving image when detecting toner empty.

In addition, Japanese Laid-Open Patent Publication No. 2006-243160 discloses an image forming apparatus repeatedly apparatus displaying a series of operation procedures for film loading from a first section to a fourth section when detecting a state in which a film is not loaded.

There are many types of guidance required for the image forming apparatus. Even in the case where the same type of guidance is required, an apparatus state may vary. For example, in an image forming apparatus having consumable products such as staples attached to a first portion and a second portion, there are an apparatus state in which a time for replacement of the consumable product attached to the first portion has come, an apparatus state in which a time for replacement of the consumable product attached to the second portion has come, and an apparatus state in which a time for replacement of the consumable products attached to the first and second portions has come.

Therefore, when an attempt is made to display guidance images corresponding to the apparatus states from the beginning to the end of the operation procedure, a large amount of guidance image data must be stored in the image forming apparatus. Particularly when a moving image is employed as the guidance images, an enormous amount of data must be stored.

Thus, in order to reduce the amount of data, it is conceivable to display one type of guidance image as a typical example regardless of the apparatus state. There is a possibility, however, that the user cannot understand the operation procedure correctly when the guidance image displayed as the typical example is different from the actual apparatus state.

### SUMMARY OF THE INVENTION

The present invention has been made to solve the problems as set forth above, and an object thereof is to provide an image forming apparatus capable of providing guidance easily understandable to a user, while reducing the capacity required to store image data.

An image forming apparatus according to the present invention is directed to an image forming apparatus including an image forming unit for forming an image on a sheet, including: a display unit for displaying a guidance image for guiding an operation procedure; a detecting unit for detecting a state of the image forming apparatus related to the operation procedure; and a display control unit for displaying, together with the guidance image, a supplemental image for indicating a difference between the operation procedure displayed by the guidance image and an operation procedure required in the state detected by the detecting unit.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram of an image forming apparatus and a finisher.

FIG. 2 is a diagram showing moving image data for guiding a staple cartridge replacement procedure.

FIG. 3 is a diagram for describing a storage area for the moving image data.

FIG. 4 is a diagram for describing a configuration of marking data (first embodiment).

FIG. 5 is a diagram showing a determination table (first embodiment).

FIG. 6 is a diagram for describing a flow of guidance display (first embodiment).

FIG. 7 is a flowchart for describing guidance display processing (first embodiment).

FIG. 8 is a diagram for describing a flow of guidance display (second embodiment).

FIGS. 9 to 12 are diagrams for describing a flow of guidance display (third embodiment).

### DESCRIPTION OF THE PREFERRED EMBODIMENTS

Embodiments of the present invention will be described hereinafter with reference to the drawings. In the following description, the same reference characters are given to the same parts and components. Their names and functions are the same.

### First Embodiment

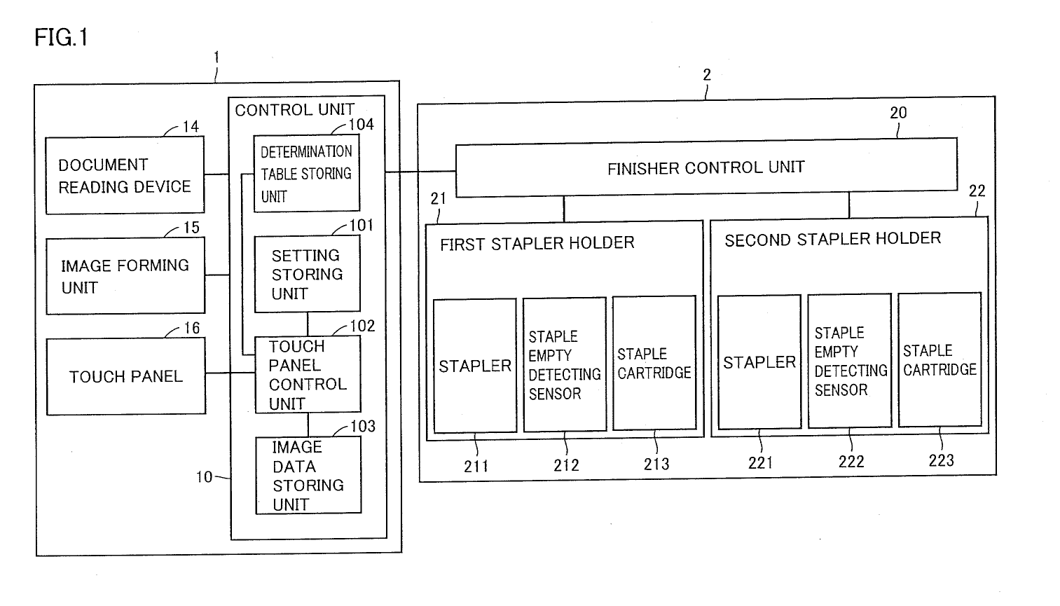

FIG. 1 is a block diagram of an image forming apparatus 1 and a finisher 2. Image forming apparatus 1 has a function of doing printing in accordance with an instruction from a computer connected by a network and a function as a facsimile, in addition to a copy function. Image forming apparatus 1 has a control unit 10, a document reading device 14, an image forming unit 15, and a touch panel 16.

Control unit 10 includes a setting storing unit 101, a touch panel control unit 102, an image data storing unit 103, and a determination table storing unit 104. A set value for image forming apparatus 1 is stored in setting storing unit 101. Image forming unit 15 includes a photoconductor drum, a charging device, an image exposure device, a developing device, a transferring device, a cleaning device, a fixing device and the like. Image forming unit 15 has a function of forming an image on a surface of a document read by document reading device 14, on a paper by using the well-known electrophotographic method.

Touch panel control unit 102 provides a copy or post-processing command to image forming apparatus 1 in accordance with a user's operation detected by touch panel 16, or causes touch panel 16 to display the contents of a command from the user. Furthermore, touch panel control unit 102 causes touch panel 16 to display a moving image for guidance and a still image for guidance.

Finisher 2 is coupled to image forming apparatus 1. Finisher 2 performs stapling processing, folding processing or the like to a paper fed from image forming apparatus 1, in accordance with a command from the user.

Finisher 2 has a finisher control unit 20, a first stapler holder 21 and a second stapler holder 22. First stapler holder 21 includes a stapler 211, a staple empty detecting sensor 212 and a staple cartridge 213. Second stapler holder 22 includes a stapler 221, a staple empty detecting sensor 222 and a staple cartridge 223.

Staple empty detecting sensor 212 is for detecting that staple cartridge 213 of first stapler holder 21 is empty of staples. Staple empty detecting sensor 222 is for detecting that staple cartridge 223 of second stapler holder 22 is empty of staples. Detection signals from staple empty detecting sensor 212 and staple empty detecting sensor 222 are inputted to control unit 10 of image forming apparatus 1 via finisher control unit 20. Based on these detection signals, control unit 10 detects an apparatus state in which staple cartridge 213 of first stapler holder 21 is empty of staples or an apparatus state in which staple cartridge 223 of second stapler holder 22 is empty of staples.

Finisher control unit 20 performs control of feeding a paper conveyed from image forming apparatus 1 to a feeding path corresponding to the setting, control of stapling a plurality of papers at first stapler holder 21 and second stapler holder 22, or the like.

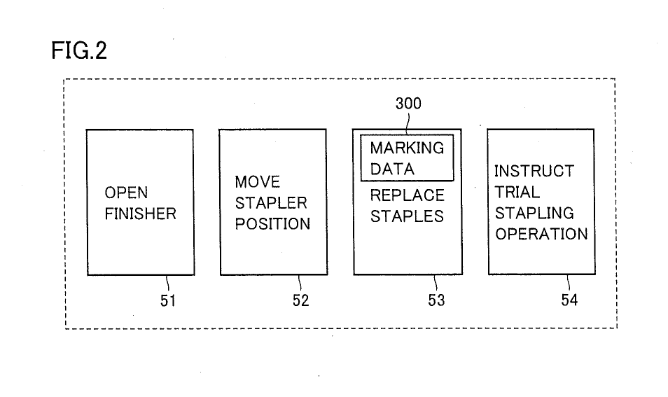

FIG. 2 is a diagram showing moving image data for guiding a staple cartridge replacement procedure. Image forming apparatus 1 according to a first embodiment has a function of causing touch panel 16 to display a guidance image for guiding the operation procedure about image forming apparatus 1. A description will now be given to a guidance image about the staple cartridge replacement procedure, as one example of the guidance image. This guidance image is a moving image. A still image may, however, be employed instead of the moving image.

As shown in the figure, the moving image data for guiding the staple cartridge replacement procedure is formed of moving image data 51 to moving image data 54. Moving image data 51 to 54 for guiding the staple cartridge replacement procedure are used to guide the procedure for replacing the staple cartridges of first stapler holder 21 and second stapler holder 22.

Moving image data 51 is for displaying an operation of removing finisher 2 from image forming apparatus 1. Moving image data 52 is for switching the contents of display so as to zoom in to a position where the stapler holder is provided.

Moving image data 53 is for displaying the manner in which the stapler holder is pulled out toward the user to replace the staple cartridge. Moving image data 54 is for guiding an operation of instructing trial stapling.

Moving image data 53 includes marking data 300. Marking data 300 is for causing touch panel 16 to display a supplemental image in addition to the guidance image. Marking data 300 specifies a type of the supplemental image and a timing to display the supplemental image. The supplemental image is for guiding the operation procedure in accordance with the current apparatus state of image forming apparatus 1 and finisher 2.

The supplemental image is a still image. A moving image may, however, be employed instead of the still image. When marking data 300 is included in the moving image data, image forming apparatus 1 causes touch panel 16 to display the supplemental image corresponding to marking data 300, in addition to the guidance image corresponding to the moving image data.

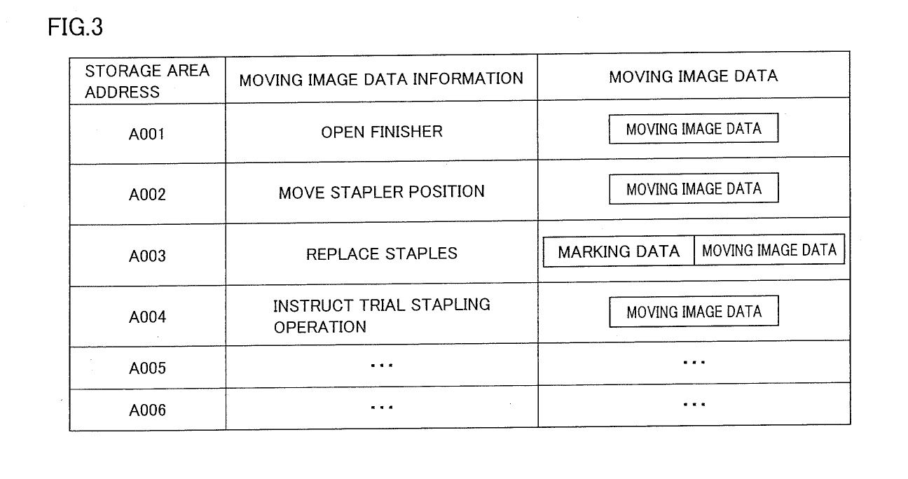

FIG. 3 is a diagram for describing a storage area for the moving image data. A plurality of types of moving image data used as the guidance image is stored in image data storing unit 103 in association with addresses of the storage area. Furthermore, moving image data information for identifying the moving image data is stored in image data storing unit 103 in association with the addresses of the storage area.

For example, moving image data of “open finisher” is stored at an address “A001” together with the moving image data information. Moving image data of “move stapler position” is stored at an address “A002” together with the moving image data information. Moving image data of “replace staples” is stored at an address “A003” together with the moving image data information. The marking data used for displaying the supplemental image is included in the top of the moving image data of “replace staples.” Moving image data of “instruct trial stapling operation” is stored at an address “A004” together with the moving image data information.

Moving image data corresponding to other types of guidance other than the moving image data corresponding to the guidance f or staple cartridge replacement shown by way of example in FIG. 3 is also stored at an address “A005” and subsequent addresses of image data storing unit 103. Control unit 10 reads the moving image data corresponding to the type of guidance from image data storing unit 103 and causes touch panel 16 to display the guidance image.

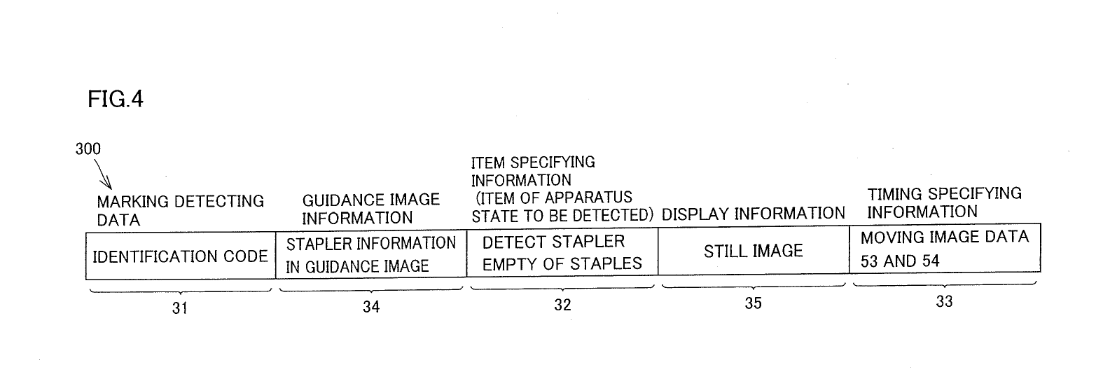

FIG. 4 is a diagram for describing a configuration of marking data 300. Marking data 300 includes marking detecting data 31, item specifying information 32, timing specifying information 33, guidance image information 34, and display information 35.

Marking detecting data 31 is data indicating that data including this marking detecting data 31 is marking data 300. Control unit 10 identifies the marking data based on whether or not an identification code defined as marking detecting data 31 is included in the top of the moving image data.

Item specifying information 32 is information indicating an item of the apparatus state to be detected. Item specifying information 32 specifies, for example, detection of a stapler empty of staples. Based on this information, control unit 10 detects whether the staple cartridge of first stapler holder 21 or second stapler holder 22 is empty of staples.

Timing specifying information 33 is information indicating a timing to display the supplemental image. Timing specifying information 33 specifies, for example, displaying the supplemental image at a timing when moving image data 53 and moving image data 54 are displayed.

Guidance image information 34 is information about the apparatus state displayed by the guidance image. FIG. 4 shows “stapler information” as the information about the apparatus state by way of example. Only one type of the guidance image information, “STP1, 2” is prepared as “stapler information.”

This “STP1, 2” refers to the guidance image showing the operation procedure for replacing the staple cartridges of both first stapler holder 21 and second stapler holder 22. Therefore, the guidance image including marking data 300 that has guidance image information 34 of “STP1, 2” shows the operation procedure for replacing the staple cartridges of both first stapler holder 21 and second stapler holder 22.

Display information 35 indicates whether the type of the supplemental image is a still image or a moving image. Image forming apparatus 1 selects the still supplemental image or the moving supplemental image in accordance with designation by display information 35.

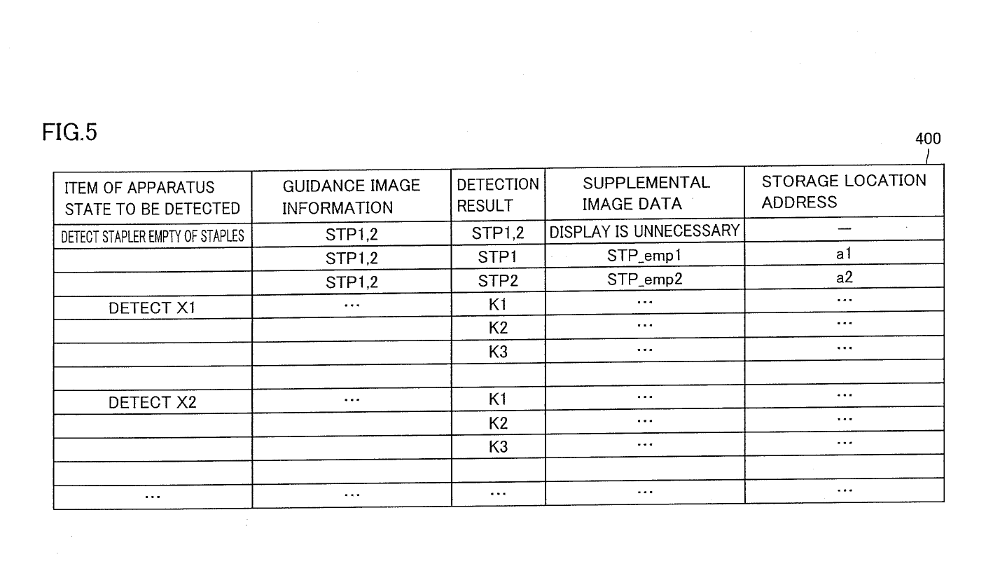

FIG. 5 is a diagram showing a determination table 400. Determination table 400 is data stored in determination table storing unit 104 (see FIG. 1). “Item of apparatus state to be detected,” “guidance image information,” “detection result,” “supplemental image data,” and “storage location address” are associated with determination table 400. Using marking data 300 and determination table 400, image forming apparatus 1 determines the type of the supplemental image and the timing to display the supplemental image.

“Item of apparatus state to be detected” is an item of the apparatus state detected before the guidance image is displayed in image forming apparatus 1. For example, “detect stapler empty of staples” means detection of a stapler holder that is empty of staples. “Item of apparatus state to be detected” includes X1, X2 and the like as other items to be detected.

“Guidance image information” is information indicating the type of the guidance image. Herein, only one type of the guidance image information, “STP1, 2” corresponds to “detect stapler empty of staples.” The guidance image information, “STP1, 2” indicates the operation procedure for replacing the staple cartridges of both first stapler holder 21 and second stapler holder 22.

“Detection result” is a result of detection of the apparatus state corresponding to “item of apparatus state to be detected.” “STP1” means that first stapler holder 21 is empty of staples. “STP2” means that second stapler holder 22 is empty of staples. “STP1, 2” means that both first stapler holder 21 and second stapler holder 22 are empty of staples.

In addition, “K1” to “K3” are detection results corresponding to the other items of the apparatus state to be detected, “X1” and “X2.”

“Supplemental image data” indicates the type of the supplemental image data displayed together when the guidance image is displayed. “STP_emp1” is supplemental image data indicating the operation procedure for replacing the staple cartridge of first stapler holder 21. “STP_emp2” is supplemental image data indicating the operation procedure for replacing the staple cartridge of second stapler holder 22.

For example, when the guidance image information is “STP1, 2” and the detection result is “STP1,” image forming apparatus 1 selects “STP_emp1” as the supplemental image. When the guidance image information is “STP1, 2” and the detection result is “STP2,” image forming apparatus 1 selects “STP_emp2” as the supplemental image. Consequently, the operation procedure for replacing the staple cartridges of both first stapler holder 21 and second stapler holder 22 is displayed by the guidance image, and at the same time, the supplemental image corresponding to the apparatus state is displayed.

Furthermore, when the guidance image information is “STP1, 2” and the detection result is “STP1, 2,” the guidance image matches the apparatus state, and thus, it is unnecessary to display the supplemental image. In this case, the supplemental image data is not displayed in image forming apparatus 1.

“Storage location address” indicates an address of image data storing unit 103 at which the supplemental image data is stored. Image forming apparatus 1 loads the supplemental image data from image data storing unit 103 by referring to the address indicated by “storage location address.”

FIG. 5 shows that only one type of the guidance image information, “STP1, 2” corresponds to “detect stapler empty of staples.” Either “STP1” or “STP2” may, however, be further added as the guidance image information. For example, when “STP1, 2” and “STP1” are prepared as the guidance image information, a method for guidance display is changed as follows.

When “detection result” is “STP1, 2,” the operation procedure for replacing the staple cartridges of both first stapler holder 21 and second stapler holder 22 is displayed as the guidance image in image forming apparatus 1. In this case, it is unnecessary to display the supplemental image. When “detection result” is “STP1,” the operation procedure for replacing the staple cartridge of first stapler holder 21 is displayed as the guidance image in image forming apparatus 1. In this case, it is unnecessary to display the supplemental image. When “detection result” is “STP2,” the operation procedure for replacing the staple cartridge of first stapler holder 21 is displayed as the guidance image in image forming apparatus 1. In this case, “detection result” does not match the guidance image. Thus, image forming apparatus 1 can call user's attention by newly displaying the supplemental image based on the data of “STP_emp2.”

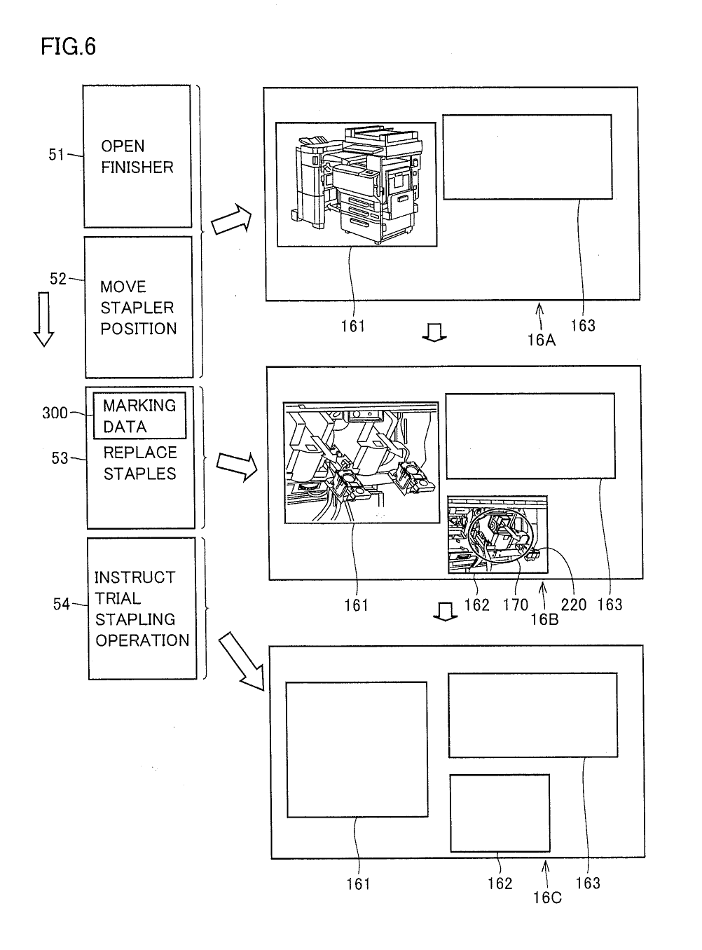

FIG. 6 is a diagram for describing a flow of guidance display. A display area 161 where the guidance image is displayed, a display area 162 where the supplemental image is displayed, and an operation area 163 used by the user to input various commands to image forming apparatus 1 are allocated to touch panel 16.

The guidance image corresponding to the type of guidance is displayed in display area 161. The guidance image is a moving image. The supplemental image corresponding to the apparatus state is displayed in display area 162. The supplemental image is a still image. The supplemental image is displayed at the timing specified by marking data 300. Marking data 300 is included in any one of the plurality of moving image data constituting the guidance image.

Image forming apparatus 1 causes touch panel 16 to display the guidance image in line with the flow of the moving image data shown by arrows in FIG. 6. Furthermore, image forming apparatus 1 causes touch panel 16 to display the supplemental image at the timing specified by marking data 300. A description will be given herein to the flow of guidance display, taking as an example the case where image forming apparatus 1 detects that the staple cartridge of second stapler holder 22 is empty of staples.

First, in screen 16A, a moving image based on moving image data 51 of “open finisher” is displayed as the guidance image in display area 161. Screen 16A shows a display state of touch panel 16 corresponding to “open finisher.” A part of the moving image of “open finisher” is displayed in display area 161 on screen 16A. While the moving image of “open finisher” is being displayed, the supplemental image is not displayed. Displaying this moving image allows the user to understand that the user needs to remove finisher 2 from image forming apparatus 1.

Next, a moving image based on moving image data 52 of “move stapler position” is displayed in display area 161. At this time, the supplemental image is not displayed on touch panel 16. FIG. 6 does not show a display state of touch panel 16 corresponding to “move stapler position.” The moving image of “move stapler position” is for switching the contents of display so as to zoom in to a position where the stapler holder is provided. This moving image allows the user to know the location where the stapler holder is provided.

Next, a moving image based on moving image data 53 of “replace staples” is displayed in display area 161. Screen 16B shows a display state of touch panel 16 corresponding to “replace staples.” A part of the moving image of “replace staples” is displayed in display area 161 on screen 16B. The moving image of “replace staples” in display area 161 on screen 16B is for pulling out both first stapler holder 21 and second stapler holder 22 toward the user.

As described above, the manner in which both first stapler holder 21 and second stapler holder 22 are pulled out toward the user regardless of whether or not to replace the staple cartridge of first stapler holder 21 or second stapler holder 22 is displayed in the moving image on screen 16B. Therefore, the user cannot determine whether to pull out the right stapler holder or the left stapler holder, using only the moving image based on moving image data 53.

If the result of determination of the apparatus state is “STP2,” staple replacement is required in second stapler holder 22. In this case, the apparatus state displayed in display area 161 on screen 16B does not match the actual apparatus state.

Thus, as shown in screen 16B, the supplemental image indicating the state in which second stapler holder 22 is pulled out is displayed in display area 162. In the supplemental image, an image 220 indicating second stapler holder 22 is displayed. Furthermore, in the supplemental image, an image 170 enclosed by a round frame indicates the manner in which second stapler holder 22 is pulled out. As a result, the user can understand more easily that second stapler holder 22 should be operated. It should be noted that instead of the supplemental image as shown in screen 16B, a supplemental image may be displayed, which indicates the manner in which only a stapler holder that requires replacement of the staple cartridge, of first stapler holder 21 and second stapler holder 22, is pulled out toward the user.

Next, a moving image based on moving image data 54 of “instruct trial stapling operation” is displayed in display area 161. This moving image is a moving image indicating the trial stapling operation using the stapler holder whose staple cartridge has been replaced. Screen 16C shows a display state of touch panel 16 when the moving image of “instruct trial stapling operation” is displayed. When switching from the moving image of “replace staples” to the moving image of “instruct trial stapling operation” is done, the supplemental image is also switched. Screen 16C does not show the moving image in display area 161 and the supplemental image in display area 162 after being switched. In the supplemental image after being switched, the manner of trial stapling using second stapler holder 22 is displayed. By referring to the supplemental image, the user can easily understand that second stapler holder 22 should be subjected to the trial stapling operation.

As described above, the moving image data for guidance of “replace staples” is commonly used regardless of whether or not to replace the staple cartridge of first stapler holder 21 or second stapler holder 22. Similarly, the moving image data for guidance of “instruct trial stapling operation” is also commonly used regardless of whether or not to replace the staple cartridge of first stapler holder 21 or second stapler holder 22. Therefore, the number of the necessary moving image data can be reduced as compared with the case where the moving image data for replacing the staple cartridge of first stapler holder 21, the moving image data for replacing the staple cartridge of second stapler holder 22 and the moving image data for replacing the staple cartridges of both first stapler holder 21 and second stapler holder 22 are different from one another. Consequently, the storage capacity of a memory required to store the moving image data can be reduced.

Moreover, when the moving image that is common regardless of the apparatus state is displayed as the guidance image, different supplemental images are displayed in accordance with the apparatus state. Therefore, user's confusion about the operation can be prevented as much as possible.

In addition, a still image is employed as the supplemental image. Therefore, the storage capacity of the memory required to store the supplemental image can be reduced as compared with the case where a moving image is employed as the supplemental image.

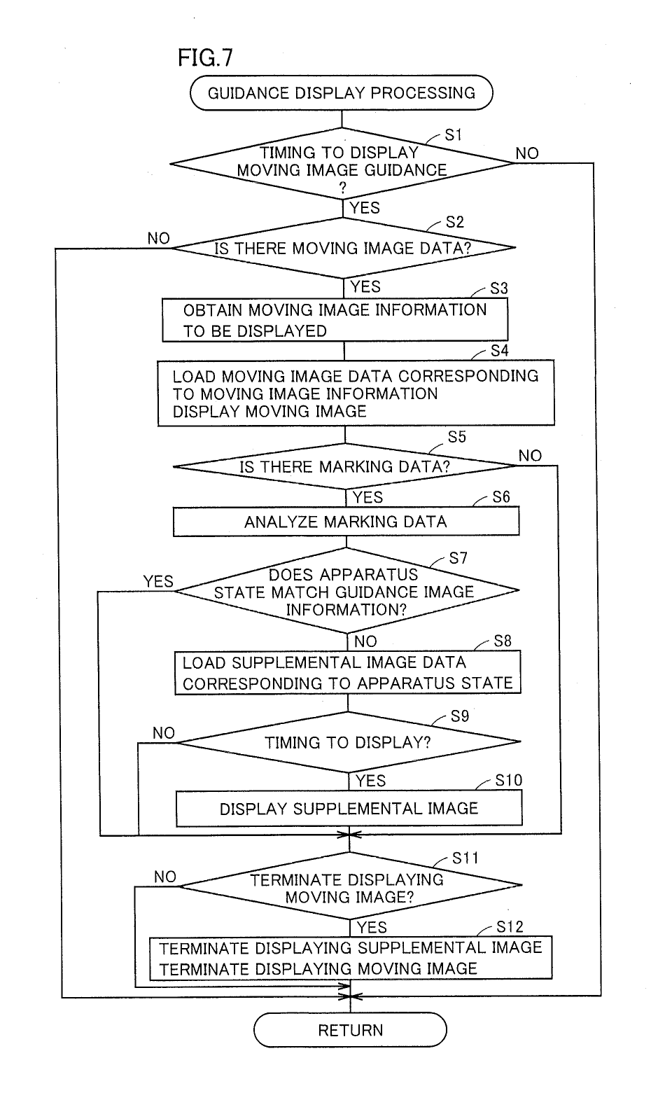

Next, a procedure of control performed by control unit 10 of image forming apparatus 1 will be described with reference to FIG. 7. FIG. 7 is a flowchart showing guidance display processing performed by control unit 10.

First, control unit 10 determines whether or not now is the timing to provide guidance display by moving images (S1).

For example, when detecting an operation of requesting guidance display, control unit 10 makes a determination as YES in S1. The operation of requesting guidance display is detected when the user operates operation area 163 on touch panel 16. Alternatively, when the need to replace the consumable products such as the staple cartridge arises, or when the need for jamming processing arises, control unit 10 makes a determination as YES in S1.

If control unit 10 makes a determination as YES in S1, control unit 10 determines whether or not there is moving image data used for guidance (S2). The moving image data used for guidance is stored in image data storing unit 103. If there is no moving image data of a type corresponding to the requested guidance, the guidance display processing is terminated. If there is moving image data of a type corresponding to the requested guidance, all moving image data information used for guidance is obtained (S3). As a result, control unit 10 obtains, for example, the moving image data information of “open finisher,” “move stapler position,” “replace staples,” and “instruct trial stapling operation” as shown in FIG. 3.

Next, control unit 10 loads moving image data corresponding to the obtained moving image information and causes touch panel 16 to display moving images sequentially (S4). As a result, the moving images based on the moving image data of “open finisher,” “move stapler position,” “replace staples,” and “instruct trial stapling operation” as shown in FIG. 3, for example, are sequentially displayed on touch panel 16.

Next, control unit 10 determines whether or not the marking data is included in the data of the displayed moving image (S5). As a result, the moving image data including the marking data is identified. If the marking data is not included in the moving image data, the processing proceeds to S11.

If the marking data is included in the moving image data, control unit 10 analyzes the marking data (S6). Specifically, control unit 10 refers to the guidance image information, the item specifying information, the display information, and the timing specifying information included in marking data 300, and compares the same with determination table 400.

Next, control unit 10 determines whether or not the current apparatus state matches the guidance image information included in marking data 300 (S7). Assume, for example, that the current apparatus state is the state in which both first stapler holder 21 and second stapler holder 22 are empty of staples. In this case, referring to FIG. 5, the result of detection of the current apparatus state is “STP1, 2.” At this time, if the guidance image information included in the marking data is “STP1, 2,” a determination as YES is made in S7. In other words, it is unnecessary to display a supplemental image. In this case, the processing proceeds to S11.

In contrast, assume that the current apparatus state is the state in which only first stapler holder 21 is empty of staples. In this case, referring to FIG. 5, the result of detection of the current apparatus state is “STP1.” At this time, if the guidance image information included in the marking data is “STP1, 2,” a determination as NO is made in S7. In this case, control unit 10 loads supplemental image data corresponding to the apparatus state (S8). Specifically, control unit 10 selects the supplemental image data of “STP_emp1” (see FIG. 5) and loads the selected data from address a1 of image data storing unit 103.

In accordance with the apparatus state detected in such a manner, the appropriate supplemental image for indicating a difference between the operation procedure displayed by the guidance image and the operation procedure required in the detected operation state is displayed together with the guidance image. Thereby, the storage capacity of the memory can be reduced, and at the same time, guidance easily understandable to the user can be realized.

Next, control unit 10 determines whether or not now is the timing to display the supplemental image, based on the timing specifying information referred to in S6 (S9). If now is not the timing to display the supplemental image, the processing proceeds to S10. If now is the timing to display the supplemental image, control unit 10 causes touch panel 16 to display the supplemental image (S10). As a result, the moving image (guidance image) for replacing the staple cartridges of first stapler holder 21 and second stapler holder 22 is displayed, and at the same time, the supplemental image corresponding to the apparatus state is displayed on touch panel 16, for example.

Next, control unit 10 determines whether or not now is the timing to terminate displaying a series of moving images for guidance (S11). For example, when the timing to terminate displaying the series of moving images based on moving image data 51 to 54 as shown in FIG. 6 comes, control unit 10 terminates displaying the moving images and also terminates displaying the supplemental image (S12). As a result, the guidance display processing by control unit 10 ends.

### Second Embodiment

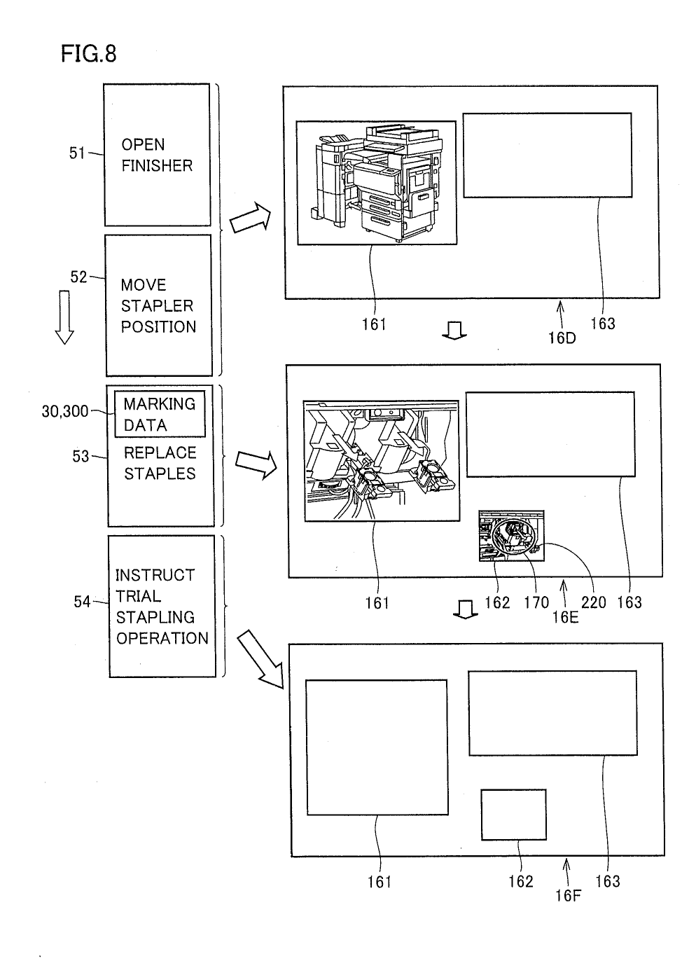

Next, a second embodiment will be described with reference to FIG. 8. FIG. 8 is a diagram for describing a flow of guidance display. FIG. 8 includes screens 16D to 16F. As compared with the first embodiment, the second embodiment is characterized in that the display size of the supplemental image displayed in display area 162 is made smaller than that of the guidance image. Therefore, as shown in FIG. 8, the display size of the supplemental image displayed in display area 162 is much smaller than that of the guidance image displayed in display area 161.

According to the second embodiment, since the display size of the supplemental image is decreased, the capacity of the memory required to store the supplemental image data can be reduced. It should be noted that the supplemental image may be either a moving image or a still image. In addition, the data size of the supplemental image may be made smaller than that of the guidance image by making the resolution of the supplemental image lower than that of the guidance image. Alternatively, the supplemental image data may be stored in image data storing unit 103 in a format having a compression ratio higher than that of the guidance image data. As a result of the foregoing, the storage capacity of the memory required to store the supplemental image can be further reduced.

### Third Embodiment

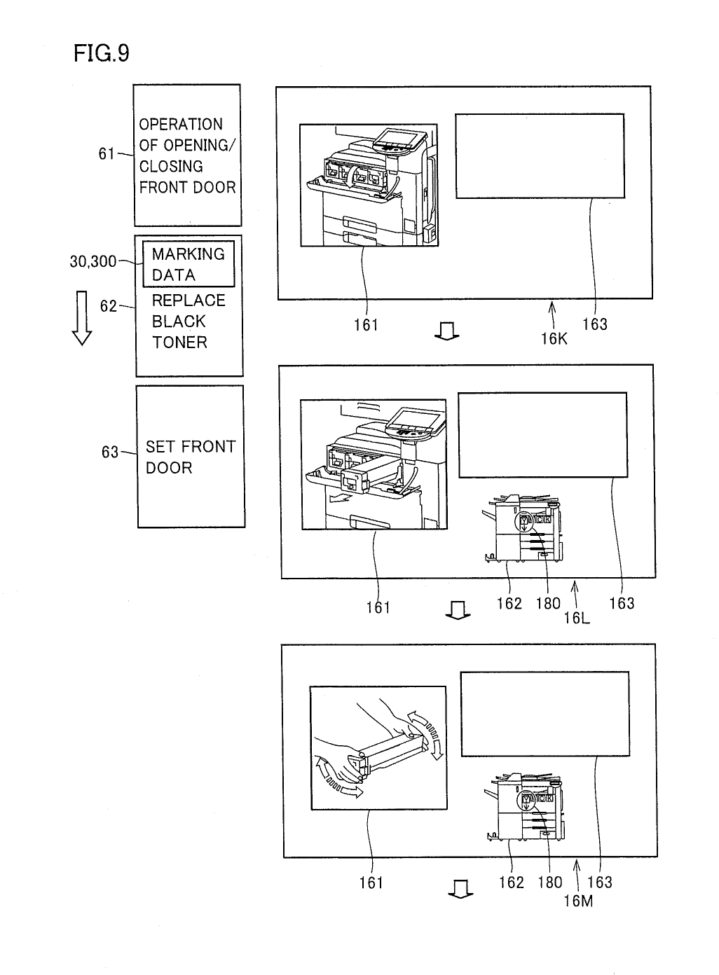

Next, a third embodiment will be described with reference to FIGS. 9 to 12. In the above first and second embodiments, guidance display has been described, taking replacement of the staple cartridge as an example. In this third embodiment, other guidance display will be described. It should be noted that the third embodiment is applicable to any of the first embodiment and the second embodiment.

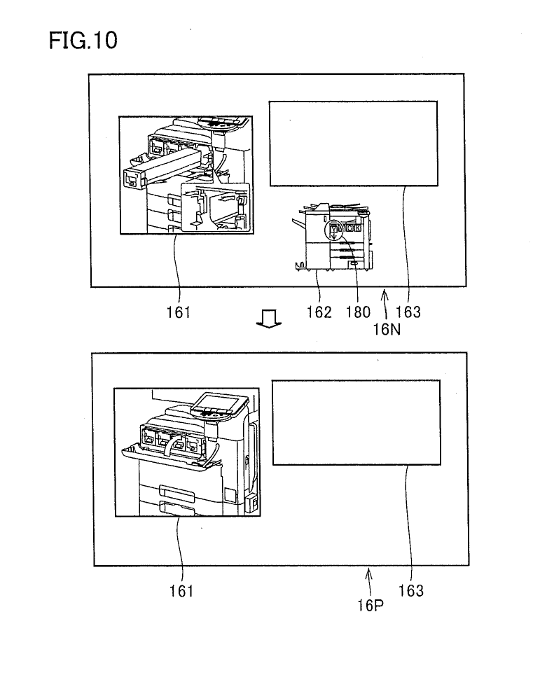

First, with reference to FIGS. 9 and 10, guidance display will be described, taking replacement of a toner cartridge as an example. Four types of toner cartridges of Y (yellow), M (magenta), C (cyan), and K (black) are attached to image forming apparatus 1. A description will now be given to guidance display for replacing the toner cartridge of Y (yellow) among these toner cartridges.

It should be noted that image forming apparatus 1 includes a toner remaining amount detecting sensor (not shown) for detecting a remaining amount of the toner cartridge for each type of the toner cartridge. Control unit 10 determines the type of the toner cartridge to be replaced, based on a detection signal of this toner remaining amount detecting sensor.

As shown in FIG. 9, moving image data 61 to 63 are used for guidance display for replacement of the toner cartridge. Moving image data 61 is for displaying the manner in which a front door of image forming apparatus 1 is opened. Moving image data 62 is for displaying the manner in which the toner cartridge of K (black) is replaced.

The marking data is included in the top of moving image data 62. Moving image data 63 is for displaying the manner in which the front door is closed after replacement of the toner cartridge ends.

First, control unit 10 causes touch panel 16 to display a moving image based on moving image data 61. As a result, as shown in FIG. 9(A), the manner in which the front door of image foaming apparatus 1 is opened to expose the toner cartridge is displayed in display area 161. The toner cartridges are attached side by side in the order of Y (yellow), M (magenta), C (cyan), and K (black) from the left when the front door is opened.

Next, control unit 10 causes touch panel 16 to display a moving image based on moving image data 62. As a result, as shown in screens 16K, 16L, 16M, and 16N, the manner in which the toner cartridge is pulled out, the manner in which toner in a new toner cartridge is loosened, and the manner in which the new toner cartridge is attached to image forming apparatus 1 are displayed in order in display area 161.

Moving image data 62 is for displaying the procedure for replacing the toner cartridge of K (black). However, the type of the toner cartridge to be replaced actually is Y (yellow). Therefore, the apparatus state does not match the guidance image based on moving image data 62.

Thus, in the third embodiment, the guidance image is displayed based on moving image data 62, and at the same time, the supplemental image corresponding to the apparatus state is displayed in display area 162. In other words, as shown in screens 16L, 16M and 16N, the supplemental image having an image 180 enclosed by a round frame at a location where the toner cartridge of Y (yellow) is attached is displayed in display area 162. Consequently, even if the guidance image that is common regardless of the type of the toner cartridge is displayed in display area 161, the user can know the position of the toner cartridge to be replaced.

Next, control unit 10 causes touch panel 16 to display a moving image based on moving image data 63. As a result, as shown in screen 16P, the manner in which the front door is closed and the operation of replacing the toner cartridge is completed is displayed in display area 161. At this time, display of the supplemental image turns off

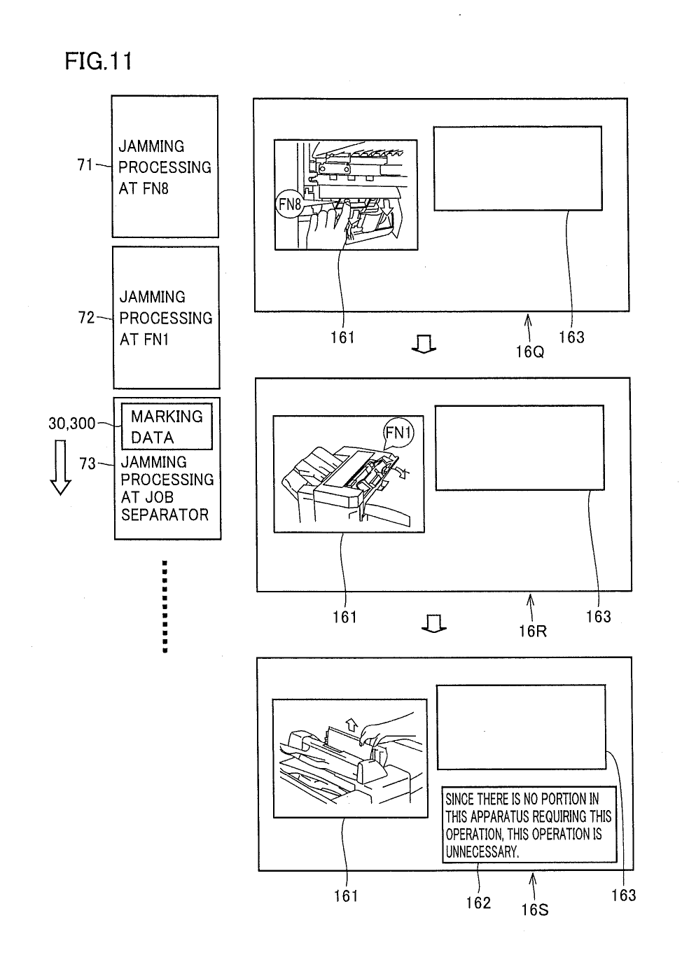

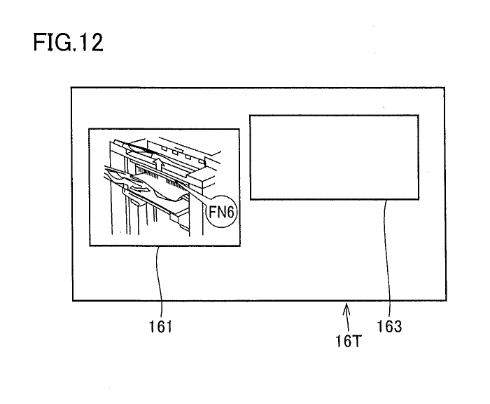

Next, guidance display for the jamming processing will be described with reference to FIGS. 11 and 12. Finisher 2 is provided with eight opening/closing units that are opened/closed to remove a jammed paper. In the following, these eight opening/closing units are referred to as FN1 to FN8, respectively. Furthermore, finisher 2 can be equipped with a job separator as an option. The job separator is a device for sorting a copy, a printout and a paper ejected from a facsimile. A description will now be given to guidance display when finisher 2 is not equipped with the job separator.

In addition to moving image data corresponding to FN1 to FN8, moving image data corresponding to the job separator is used for guidance display for the jamming processing. Among these moving image data, FIG. 11 shows only the moving image data corresponding to FN1, FN8 and the job separator. Moving image data 71 shown in FIG. 11 is for displaying the manner in which FN8 is opened to remove a paper. Moving image data 72 is for displaying the manner in which FN1 is opened to remove a paper. Moving image data 73 is for displaying the manner in which a paper is removed from the job separator.

The marking data is included in the top of moving image data 73.

First, control unit 10 reproduces moving image data 71. As a result, as shown in screen 16Q, the manner in which FN8 of finisher 2 is opened to remove a paper is displayed in display area 161.

Next, control unit 10 causes touch panel 16 to display a moving image based on moving image data 72. As a result, as shown in screen 16R, the manner in which FN1 of finisher 2 is opened to remove a paper is displayed in display area 161.

Next, control unit 10 causes touch panel 16 to display a moving image based on moving image data 73. As a result, as shown in screen 16S, the manner in which a paper is removed from the job separator mounted on finisher 2 is displayed in display area 161. When finisher 2 is not equipped with the job separator, the apparatus state does not match the guidance image based on moving image data 73.

Thus, in such a case, in the third embodiment, the guidance image is displayed based on moving image data 73, and at the same time, the supplemental image for instructing the user of the apparatus state is displayed in display area 162. In other words, as shown in screen 16S, a message saying “Since there is no portion in this apparatus requiring this operation, this operation is unnecessary.” is displayed in display area 162. Consequently, even if the guidance image that is common regardless of whether the job separator is mounted or not is displayed in display area 161, the user is never confused about the jamming processing operation.

After moving image data 73, control unit 10 causes touch panel 16 to sequentially display moving images based on not-shown moving image data. As a result, the manner in which the remaining opening/closing units are opened to remove a paper is displayed sequentially in display area 161. Then, finally, as shown in screen 16T, the manner in which FN6 of finisher 2 is opened to remove a paper is displayed in display area 161.

As described above, according to the first to third embodiments, the moving image for guidance that is common regardless of the apparatus state is used at the time of guidance display, and thus, the storage capacity required to store the moving image data can be minimized. Moreover, according to the first to third embodiments, when reproduction of the moving image for guidance proceeds and the situation in which the operation procedure varies depending on the apparatus state is reached, the supplemental image corresponding to the apparatus state is displayed together with the moving image for guidance. Therefore, even an unfamiliar user can understand the contents of guidance without being confused about the situation in which the contents of guidance based on the moving image is different from the apparatus state.

Next, a modification and the like will be listed.

(1) Image forming apparatus 1 may be provided with a display unit designed specifically for displaying the guidance image and the supplemental image. In addition, a configuration in which image forming apparatus 1 is independent of finisher 2 has been described in each of the embodiments set forth above. A configuration in which image forming apparatus 1 itself includes the finisher may, however, be employed.

(2) Determination table storing unit 104 may be implemented by an ROM (Read Only Memory) having a control program of control unit 10 stored thereon. Alternatively, determination table storing unit 104 may be implemented by a memory different from the ROM having the control program of control unit 10 stored thereon.

(3) The guidance image is obtained by appropriately combining and reproducing a plurality of types of moving image data depending on the type of guidance. For example, FIG. 2 shows the four moving image data for guiding the staple cartridge replacement procedure. Each of these moving image data can be used as a part of various types of guidance images.

(4) When the guidance image is formed of the plurality of moving images as shown in FIG. 2, each moving image may be displayed using either a method (a) or a method (b) described below.

(a) The plurality of moving images are sequentially switched and displayed every time a certain time period elapses. When display of all moving images ends, the moving image that was first displayed is again displayed. In addition, in the middle of displaying the plurality of moving images, the supplemental image corresponding to the apparatus state is displayed.

(b) The plurality of moving images are sequentially switched and displayed based on detection of the operation by the user. For example, when it is detected that the user performs the operation procedure displayed by a first moving image among the plurality of moving images, switching from the first moving image to a second moving image is done. In addition, in the middle of displaying the plurality of moving images, the supplemental image corresponding to the apparatus state is displayed.

(5) When there are a plurality of portions where the actual apparatus state is different from the guidance image, the supplemental image corresponding to the actual apparatus state is displayed in image forming apparatus 1 for each portion.

(6) Image forming apparatus 1 controls the timing to display the supplemental image, based on the time period over which the guidance image is displayed. For example, when a first time period has elapsed since display of the guidance image started, image forming apparatus 1 starts displaying the supplemental image. Next, when a second time period has elapsed since the display of the supplemental image started, image forming apparatus 1 terminates the display of the supplemental image.

Alternatively, image forming apparatus 1 may control the timing to display the supplemental image, based on image frames constituting the moving image. For example, when reproduction of a top image frame to a first image frame among a plurality of image frames constituting the moving image is completed, image forming apparatus 1 starts displaying the supplemental image. Furthermore, when reproduction of the first image frame to a second image frame is completed, image forming apparatus 1 terminates the display of the supplemental image.

(7) In the third embodiment, if the operation procedure related to the job separator is displayed by the guidance image when image forming apparatus 1 is not equipped with the job separator, the message saying that the operation related to the job separator is unnecessary is displayed. It is desirable to perform such control with regard to not only the job separator but also an optional attachment like the job separator.

In image forming apparatus 1 in which whether or not to enable a certain type of function can be switched by operation of a setting switch, there may possibly be an operation procedure required only when the function is enabled. In this case, in image forming apparatus 1 with the function disabled, it is desirable to display a message saying that the operation procedure is unnecessary, when the operation procedure is displayed by the guidance image.

(8) The supplemental image may be displayed to overlap the guidance image. For example, it is conceivable to display image 170 enclosed by the round frame over the second stapler holder in the guidance image displayed in display area 161 in screen 16B. In this case, it is unnecessary to display the supplemental image in display area 162 in screen 16B.

Alternatively, image forming apparatus 1 may be provided with a display screen different from touch panel 16 to display one of the guidance image and the supplemental image on touch panel 16 and to display the other on the display screen.

(9) The configuration in which the supplemental image is always displayed together with the guidance image has been described as an example in each of the embodiments set forth above. However, a configuration in which the guidance image is not displayed when the supplemental image is displayed may be employed.

(10) There may also be provided a program that performs the control as described in the above flowchart by causing a computer to work. This program may be recorded on a computer-readable recording medium such as a flexible disk, a CD-ROM (Compact Disk-Read Only Memory), an ROM, an RAM, and a memory card attached to the computer, and may be provided as a program product.

Also, the program may be recorded on a recording medium such as a hard disk built into the computer for providing the program. Further, the program may be provided by downloading over the network.

The program may be such that a necessary module of program modules provided as a part of the operating system (OS) of the computer is called in a predetermined array and at a predetermined timing, and performs the processing. In this case, the program itself does not include the above module and the processing is performed in cooperation with the OS. The program according to the present invention may also include such a program that does not include the module.

In addition, the program according to the present invention may be incorporated into a part of another program and may be provided. In this case as well, the program itself does not include the module included in the above another program and the processing is performed in cooperation with another program. The program according to the present invention may also include such a program incorporated into another program.

The program product thus provided is installed in a program storage such as a hard disk for execution. The program product includes a program itself and a recording medium having the program recorded thereon.

According to the above configuration, the supplemental image for indicating a difference from the operation procedure displayed by the guidance image is displayed together with the guidance image. Therefore, even if a typical guidance image that does not correspond to the apparatus state is displayed, the user can understand the correct operation procedure by looking at the supplemental image. Consequently, it is not required to prepare many guidance images corresponding to the apparatus states, and all that is required is to prepare the typical guidance image. Therefore, the storage capacity required to store the guidance image data can be minimized.

Although the present invention has been described and illustrated in detail, it is clearly understood that the same is by way of illustration and example only and is not to be taken by way of limitation, the scope of the present invention being interpreted by the terms of the appended claims.

What is claimed is:

1. An image forming apparatus including an image forming unit for forming an image on a sheet, comprising:
a display unit for displaying a guidance image for guiding an operation procedure;
a detecting unit for detecting a state of said image forming apparatus related to said operation procedure; and
a display control unit for displaying, together with said guidance image, a supplemental image for indicating a difference between the operation procedure displayed by said guidance image and an operation procedure required in said state detected by said detecting unit.

2. The image forming apparatus according to claim 1, further comprising
a storing unit for storing data for displaying said guidance image, said data including item specifying information for specifying an item of said state to be detected by said detecting unit, wherein
said detecting unit detects said state based on said item specifying information.

3. The image forming apparatus according to claim 2, wherein
said data for displaying said guidance image includes guidance image information for identifying said state displayed by said guidance image,
said storing unit stores said item specifying information, said guidance image information, and information for identifying data about said supplemental image in association with one another, and
said image forming apparatus further comprises
a selecting unit for selecting said supplemental image corresponding to said state detected by said detecting unit, based on said information stored in said storing unit in association with one another.

4. The image forming apparatus according to claim 3, further comprising
a determining unit for determining whether or not said state displayed by said guidance image is different from said state detected by said detecting unit, by comparing said state identified by said guidance image information with said state detected by said detecting unit.

5. The image forming apparatus according to claim 4, wherein
said data for displaying said guidance image includes timing specifying information for specifying a timing to display said supplemental image, and
said display control unit displays said supplemental image at the timing specified by said timing specifying information.

6. The image forming apparatus according to claim 5, wherein
said guidance image is formed of a plurality of image data,
said display control unit displays said guidance image by reproducing the plurality of image data in a predetermined order,
marking data including said item specifying information, said timing specifying information and said guidance image information is included in any one of said plurality of image data, and
said display control unit identifies image data including said marking data, when reproducing said plurality of image data in said predetermined order.

7. The image forming apparatus according to claim 2, further comprising
a determining unit for determining whether or not said state displayed by said guidance image is different from said state detected by said detecting unit, and
said display control unit displays said supplemental image on condition that said determining unit determines that said state displayed by said guidance image is different from said state detected by said detecting unit.

8. The image forming apparatus according to claim 1, wherein
said image forming apparatus can be changed into an apparatus configuration that does not require a part of said operation procedure, and
when a guidance image corresponding to an unnecessary operation procedure is displayed, said display control unit displays a supplemental image indicating that an operation corresponding to said guidance image is unnecessary.

9. The image forming apparatus according to claim 1, wherein said supplemental image is a still image.

10. The image forming apparatus according to claim 1, wherein said supplemental image is a moving image.

11. The image forming apparatus according to claim 1, wherein said supplemental image is smaller in data size than said guidance image.
